(19) United States
(12) Patent Application Publication
(10) Pub. No.: US 2026/0062038 A1
(43) Pub. Date: Mar. 5, 2026

(54) SHOCK-ABSORBING DEVICE

(71) Applicant: Aleksandr Aleksandrovich ANDREEV, Moscow (RU)

(72) Inventor: Aleksandr Aleksandrovich ANDREEV, Moscow (RU)

(21) Appl. No.: 18/685,264

(22) PCT Filed: Sep. 18, 2020
(86) PCT No.: PCT/RU2020/050232

§ 371 Date: Apr. 28, 2025

(30) Foreign Application Priority Data
Dec. 6, 2019 (RU) 2019140005

(51) Int. Cl. B61G 9/00; F16F 7/08

(52) U.S. Cl. CPC B61G 9/00; F16F 7/08; F16F 2222/04

(57) ABSTRACT

A shock-absorbing device comprises a hollow housing with a closed end section and an opposing open end section through which a main axis passes, a resilient system disposed in a bottom section of the housing, a pressing element, and a friction system disposed in the open section of the housing. The resilient system is formed by a dynamic load absorber located in the closed part of the housing along the main axis of the housing on the guide bar. The guide bar has a head for installation thereof in a recess formed in the closed bottom section of the housing for centering the guide bar relative to the main axis. All structural components of the friction system and the resilient system are provided and arranged such that the working stroke of the shock-absorbing device is from 110 to 120 mm.

### CROSS-REFERENCES

The current patent application is the national stage application for the PCT application No. PCT/RU2020/050232, filed on Sep. 18, 2020, which claims priority to Russian application RU2019140005 filed on Dec. 6, 2019, all of which are incorporated herein by reference in their entirety.

### FIELD OF THE INVENTION

The invention refers to railway transport, namely to shock-absorbing units of coupling and automatic coupling units of the railway stock and is intended for energy absorption and axial force absorption influencing the rolling stock.

### BACKGROUND OF THE INVENTION

In the prior equipment, we see various designs of shock-absorbing units, in particular, the shock-absorbing unit (RF Patent No. 169528, B61G9/00, issued on 30 Sep. 2016), which contains a glass-shaped housing, where symmetrically with its inner walls the push cone is located, having contact with friction wedges, resting on a base plate. The wedges are in contact via their side surfaces with the fixed plates and bronzed friction liners fixed in the housing windows. The movable friction plates are installed between external surfaces of the fixed plates and the internal housing walls. The return and retaining device, which has the shape of polymeric elastic elements, is located under the base plate. The set of polymeric elastic elements together with base plate, compression housing and wedges are tightened with a nut and bolt inserted through an opening in the bottom of the housing. The angle between the push cone and friction wedge is more than 42° but less than 47°. Ceramic and metal elements on the fixed plates are changed to the brass friction liners. Friction wedges are equipped with compensators of the angles'difference.

The drawback of shock-absorbing units of such type is difficulty of assembly and service, the absence of polymeric elastic elements unification. Moreover, the presence of the housing friction surfaces with the unit friction parts leads to the fast wearing of the housing walls and unstable operation of the shock-absorbing unit, thus reducing the resource and the unit reliability.

The closest comparable device in the prior state of the art is the shock-absorbing unit (RF Patent No. 2593732C2, B61G 9/06, issued on 15.09.2011), which includes an empty housing with closed end part and the opposite opened end part, through which the main axis passes, an elastic system located in the lower part of the housing and the friction system located in the opened part of the housing. The last includes the items listed below. The friction wedge located on the main axis of the housing, one end of which extends from the housing and the second one located at the top of the opened part of the housing; besides the friction wedge this has the first and the second inclined surface. The first and the second friction shoes, which are located on both sides of the friction wedge, wherein each of the said friction shoes has first, second, and third inclined surfaces. Wherein the first inclined surface of the friction wedge interacts with the first inclined surface of the first friction shoe and the second inclined surface of the friction wedge interacts with the first inclined surface of the second friction shoe. Moreover, the first and the second inclined surfaces of the friction wedge and the first inclined surface of each friction shoe are located relative to the main housing axle under the first pre-determined angle. The first and the second U-shaped barrier plates, moreover, the first U-shaped barrier plate located on the side of the first friction shoe and the second U-shaped barrier plate is located on the side of the second friction shoe. Each U-shaped barrier plate has an inclined surface.

Meanwhile, the inclined surface of the first U-shaped barrier plate interacts with the second inclined surface of the first friction shoe and the inclined surface of the second U-shaped barrier plate interacts with the second inclined surface of the second friction shoe. Furthermore, the inclined surface of each U-shaped barrier plate and the second inclined surface of each friction shoe are located relative to the main axis of the housing at a second pre-determined angle. The first and the second friction plates, moreover, the first friction plate is located on the side of the first U-shaped barrier plate and the second friction plate is located on the side of the second U-shaped barrier plate. The first and the second C-shaped wear liners, whereby the first C-shaped wear liner located on the side of the first friction plate, the second C-shaped wear liner is located on the side of the second friction plate and fixed in the slots of the side walls of the housing. The compression element made with the first and the second inclined surfaces located on the protruding part of the compression element, each of which interacts with the third inclined surface of the corresponding friction shoe. Moreover, the first and second inclined surfaces of the compression element and the third inclined surface of each friction shoe are located relative to the main axis of the housing at a third pre-determined angle. The elastic system is formed by an elastic element located in the closed part of the housing along the main axis of the housing. The central plate is made with a ledge in its lower part for centering on the main axis of the housing. The compression element is made with a flat inner horizontal surface with the possibility of interaction with an elastic element located in the closed part of the housing. Moreover, in the center of the compression element there is a hole aligned with the main axis of the housing for centering relative to the main axis by placing in it a part of the centering rod during assembly, followed by removal of the centering rod located along the main axis of the housing. The compression element is formed by elastomeric elements unit centered between each other by means of plates installed between them, placed perpendicular to the main axis. Each barrier plate and each friction shoe is equipped with lubricating liners. A spring is installed between the friction wedge and the compression element to create a force supporting the friction wedge in its initial position. The compression element interacts with both friction plates and has ledges interacting with the lower ends of the friction plates, with which the force from the elastic element formed by the elastomeric elements unit is transmitted through the pressure element to both friction plates and returns them to their initial position after each stress or force impact on the absorbing unit. On a horizontal surface in the lower closed part of the housing and on the outer horizontal surface of the compression element there is an annular slot intended for the additional centering of the elastic element formed by the elastomeric elements unit.

The drawback of the known shock-absorbing unit is the lack of a rod, which centers the elastomeric elements during operation and a complex system for centering the elastomeric elements along the main axis. In addition, the design of the unit uses a spring, which complicates the device and the design of the compression element, which in this design makes the device heavier. Moreover, there are no lubricating liners between C-shaped wear liners and friction plates, which negatively affects the reliability of the device.

### SUMMARY OF THE INVENTION

The task to which the announced invention is directed is to develop an improved design of the shock-absorbing unit, without the drawbacks of the aforementioned comparable devices, as well as to expand the range of technical means for achieving the stipulated purpose.

The technical result of the invention is to increase reliability and service life due to a more accurate centering of the interacting structural elements of the friction and elastic systems when exposed to dynamic loads and increase the energy consumption of the unit given simultaneous simplification of the design and ensuring the technical requirements in the Russian Federation and the CIS countries for absorbing devices of coupling (automatic coupling) devices on railway rolling stock.

The specified technical result is achieved due to the fact that in the shock-absorbing unit, which includes the empty housing with the closed end part and the opposite opened end part, through which the main axis passes, the elastic system, located in the lower part of the housing and the friction system, located in the opened part of the housing. The latest includes the items listed below. The friction wedge located on the main axis of the housing, one end of which extends from the housing and the second one is located at the top of the opened part of the housing; besides the friction wedge it has the first and the second inclined surface. The first and the second friction shoes, which are located on the both sides from the friction wedge, wherein each of said friction shoes has first, second, and third inclined surfaces. Wherein the first inclined surface of the friction wedge interacts with the first inclined surface of the first friction shoe and the second inclined surface of the friction wedge interacts with the first inclined surface of the second friction shoe. Moreover, the first and the second inclined surfaces of the friction wedge and the first inclined surface of each friction shoe are located relative to the main housing axle under the first pre-determined angle. The first and the second barrier plates, moreover, the first U-shaped barrier plate located on the side of the first friction shoe and the second barrier plate is located on the side of the second friction shoe. Each barrier plate has an inclined surface. Meanwhile, the inclined surface of the first barrier plate interacts with the second inclined surface of the first friction shoe and the inclined surface of the second barrier plate interacts with the second inclined surface of the second friction shoe. Moreover, the inclined surface of each barrier plate and the second inclined surface of each friction shoe are located relative to the main axis of the housing at a second pre-determined angle. The first and the second U-shaped friction plates, moreover, the first U-shaped friction plate is located on the side of the first barrier plate and the second U-shaped friction plate is located on the side of the second barrier plate. The first and the second wear liners, whereby the first wear liner located on the side of the first U-shaped friction plate, the second wear liner is located on the side of the second U-shaped friction plate and fixed in the slots of the side walls of the housing. The compression element made with the first and the second inclined surfaces located on the protruding part of the compression element, each of which interacts with the third inclined surface of the corresponding friction shoe. Moreover, the first and second inclined surfaces of the compression element and the third inclined surface of each friction shoe are located relative to the main axis of the housing at the third pre-determined angle. The elastic system is formed by a dynamic load absorber located in the closed part of the housing of the guide pin. The compression element is made with a flat inner horizontal surface with the possibility of interaction with the dynamic load absorber located in the closed part of the housing. Moreover, in the center of the compression element there is a hole aligned with the main axis of the housing for centering relative to the main axis by placing in it a part of the guide pin located along the main axis of the housing. The dynamic load absorber is formed by elastomeric elements unit centered between each other by means of plates and the elastomeric element, installed between them. Moreover, each plate of each elastic element is made with ledges in such a way that the plate ledges interact with the upper and the lower surfaces of the elastomeric element and provide relative positioning of the relative plates and elastomeric element. Each plate is made in the center with a hole aligned with the main axis of the housing for the centering relative to the main axis of the housing for centering relative to the main axis by placing in it a part of the guide pin. Moreover, the guide pin is made with a head and the inner horizontal surface of the closed part of the housing has a conical or cylindrical slot located on the main axis of the housing and designed to center relative to the main axis of the guide pin housing by installing the guide pin in the slot, pressed and fixed with the lower plate of the lower elastomeric unit. Moreover, the housing is made with U-shaped ledges located on the opposite inner surfaces of the open end part of the housing and with the oppositely directed C-shaped ledges placed on the opposite sides of the lower part. Moreover, each U-shaped ledge is made with a flat or concave lower surface with the possibility of interaction with the corresponding surfaces of the support arms of the friction wedge. Each C-shaped ledge is made with a lower horizontal flat or concave surface, an upper horizontal flat or concave surface and a side vertical surface. Moreover, each lateral ledge of each barrier plate is located inside the corresponding C-shaped ledge on opposite sides of the lower part of the housing, so that the lower horizontal flat or concave surface of each C-shaped ledge of the housing in the lower part interacts with the lower horizontal flat or convex surface of the corresponding lateral ledge barrier plate. The upper horizontal flat or concave surface of each C-shaped ledge of the housing in the lower part is located with a technological gap from the upper horizontal flat of convex surface of the corresponding lateral ledge of the barrier plate. The lateral vertical surface of each C-shaped ledge of the housing in the lower part is located with a technological gap from the lateral vertical surface of the corresponding lateral ledge of the barrier plate. The compression element is made with four ledges, each ledge made with an upper surface; the first and the second U-shaped plates are made with the ledges on the sides. Moreover, each ledge is made with the lower surface in such a way that when the unit returns to its initial working position, the lower surface of the ledge of the first and the second U-shaped plates interact with the surface of the upper corresponding ledge of the compression element. Whereby all the structural elements of the friction system and the elastic system are made and placed in such a way that the working stroke of the unit is 110 mm to 120 mm.

It is reasonable that the elastomer element was made of a polymeric material.

It is reasonable that the first pre-determined angle is about 45±5° and the second pre-determined angle is about 4±3° and the third pre-determined angle is about 75±5°.

It is reasonable that the friction shoes are provided with lubricating liners mounted on the side of the barrier plates.

It is reasonable that the U-shaped friction shoes are provided with lubricating liners mounted on the side of the barrier plates.

It is reasonable that the U-shaped friction shoes are provided with the lubricating liners mounted on the side of the wear liners.

It is reasonable that the ledges of the plate of the elastic element were made of cylindrical shape.

It is reasonable that the ledges of the plate of the elastic element were made in the shape of sharp pins-teeth.

### BRIEF DESCRIPTION OF THE DRAWINGS

The invention is illustrated by the drawings where

FIG. 1 shows the shock-absorbing unit with an elastic element on a guide pin in a section;

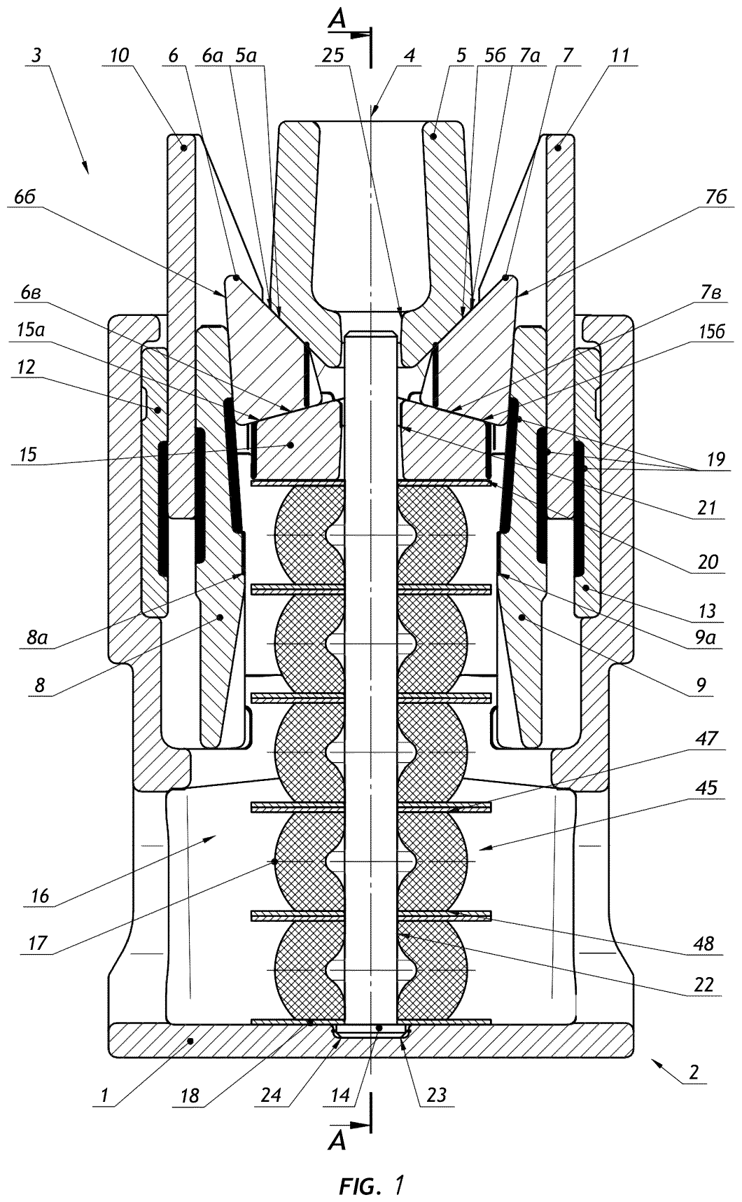

FIG. 2 shows the shock-absorbing unit with an elastic element on a guide pin in a section with a designation of the pre-determined angles;

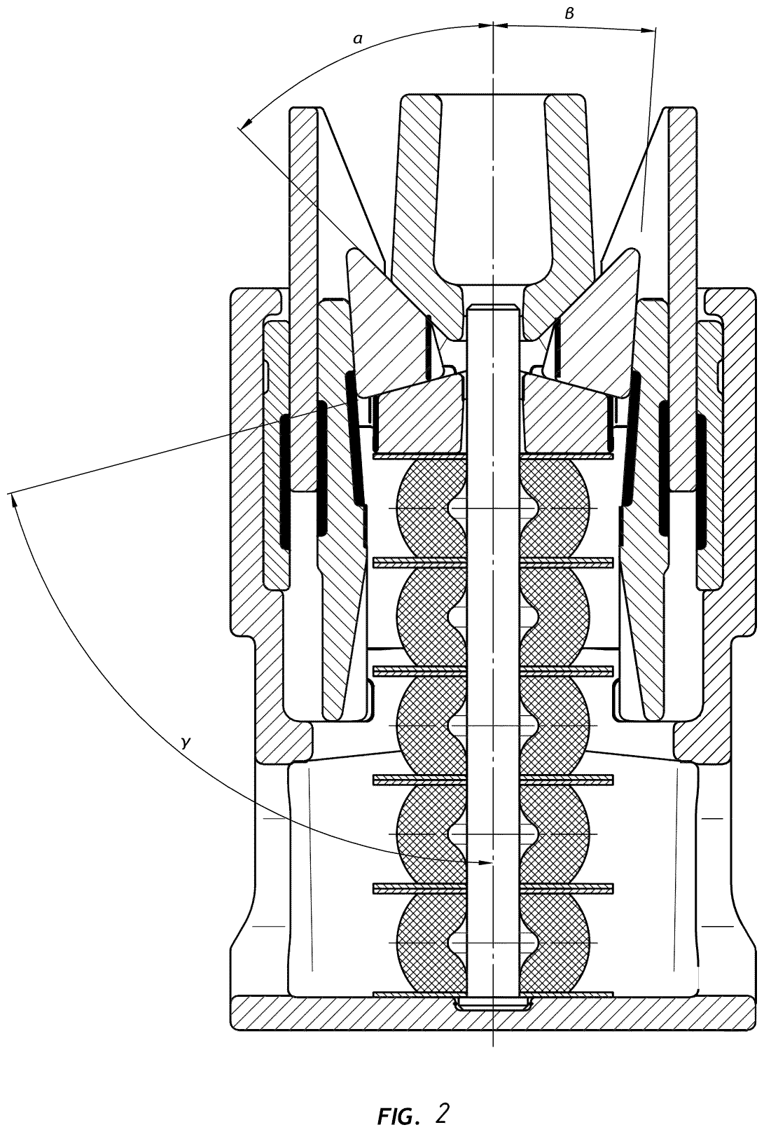

FIG. 3 shows A-A section on FIG. 1;

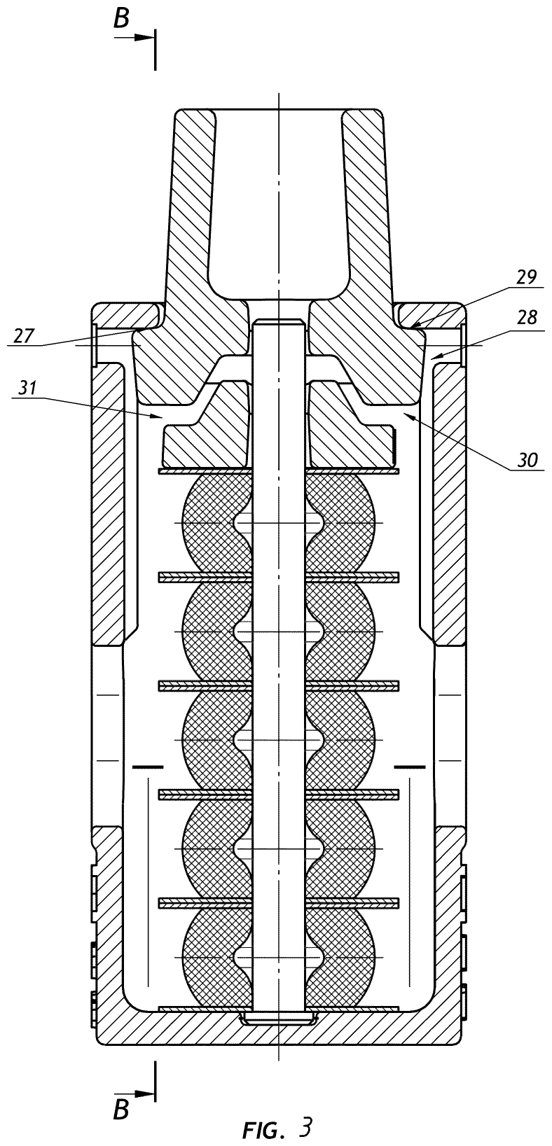

FIG. 4 shows B-B section on FIG. 3;

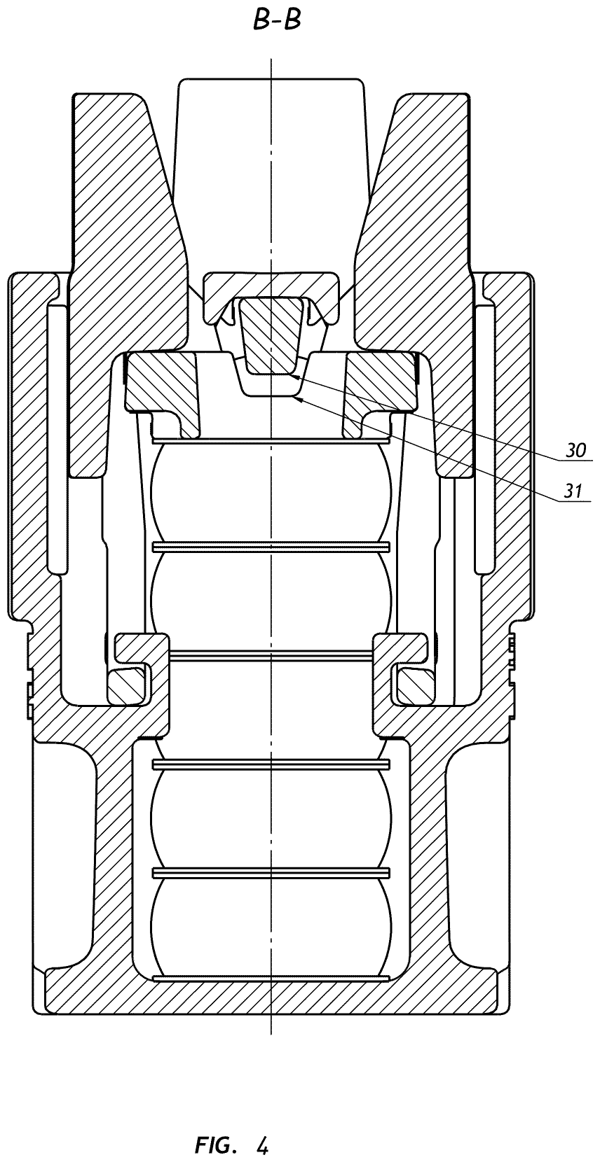

FIG. 5 shows the section of the shock-absorbing unit housing;

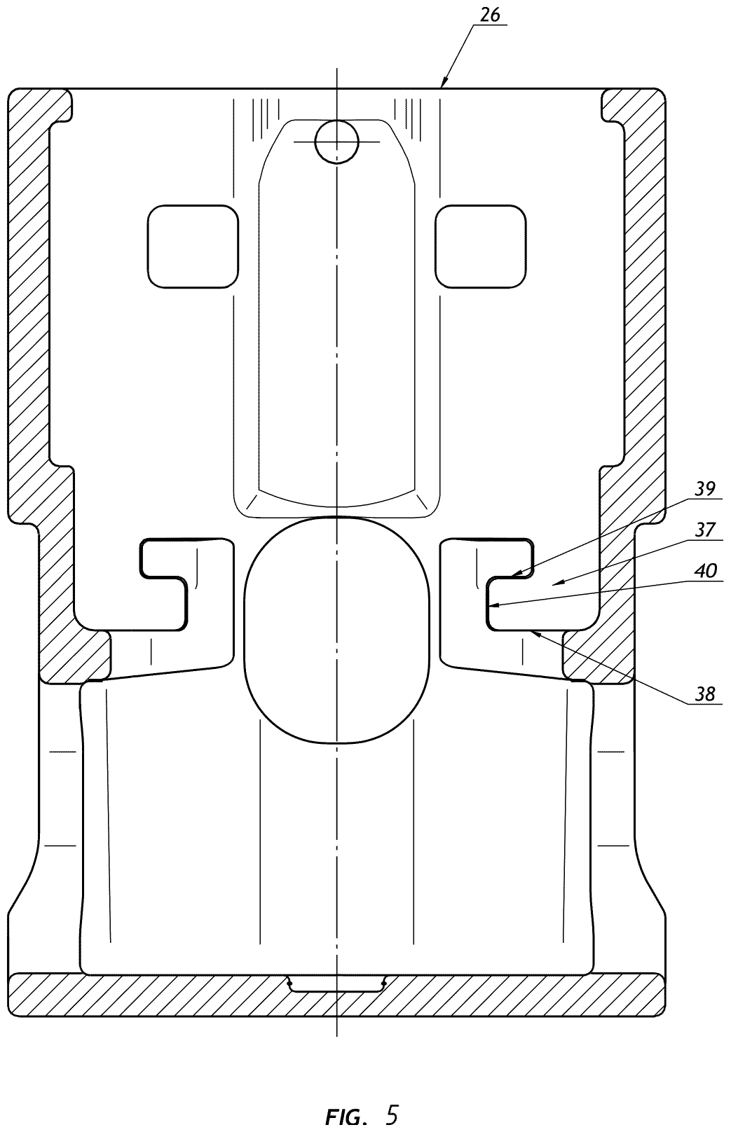

FIG. 6 shows the barrier plate;

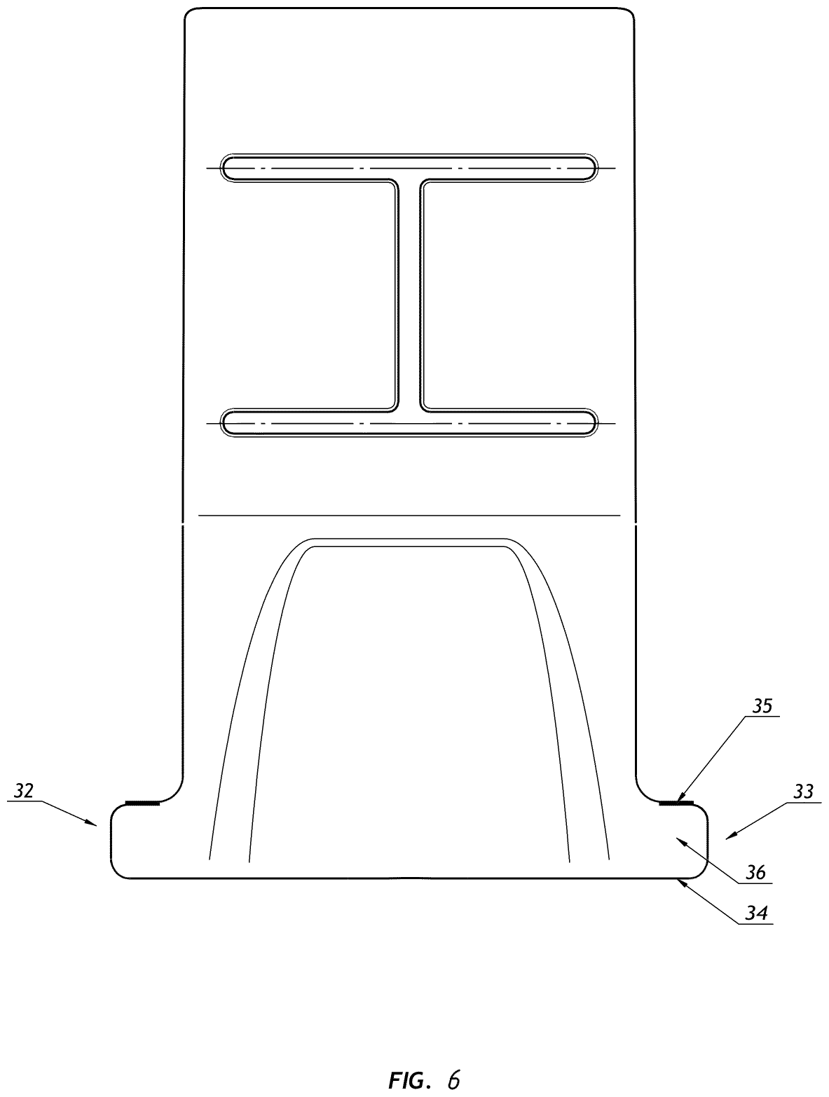

FIG. 7 shows U-shaped friction plate;

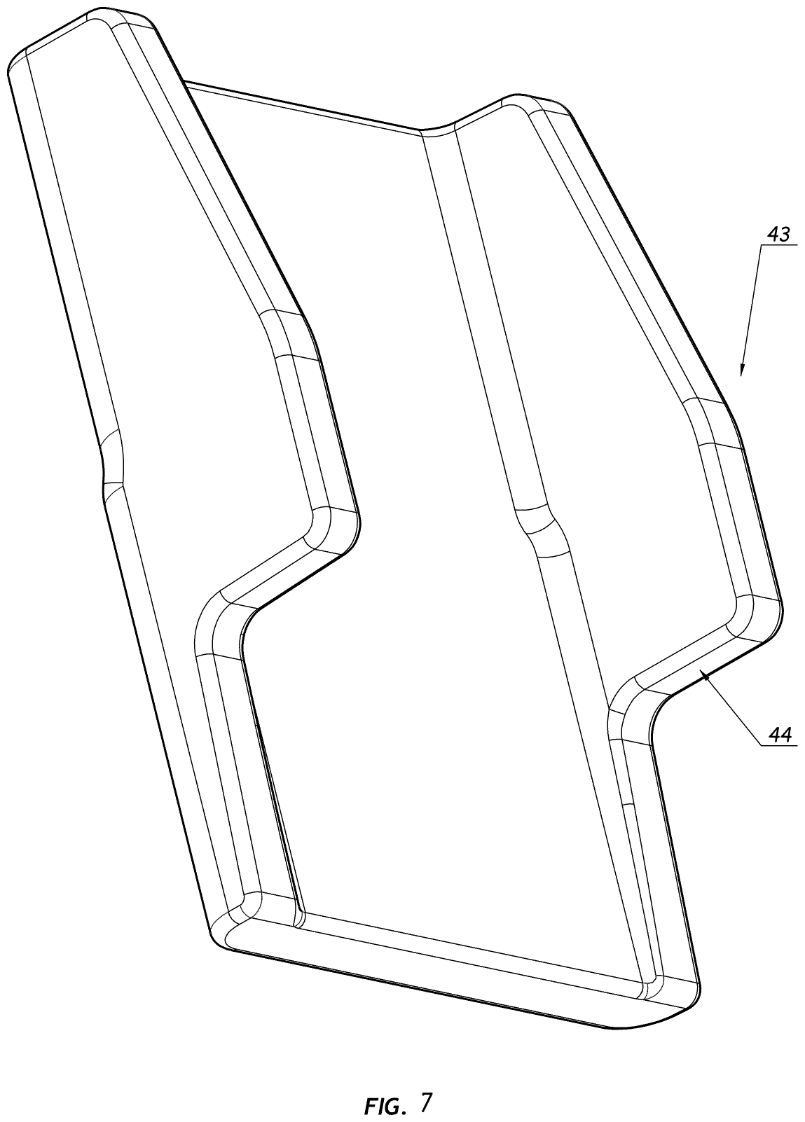

FIG. 8 shows the compression element;

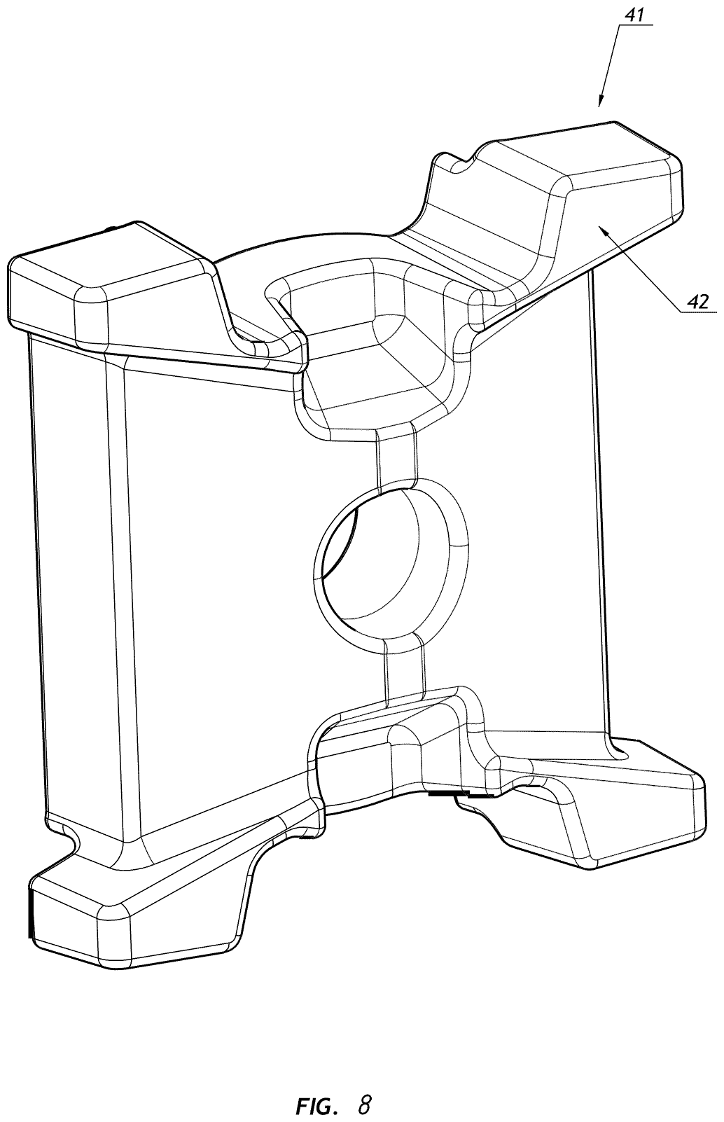

FIG. 9 shows the plate of the elastic element with the ledges of cylindrical shape;

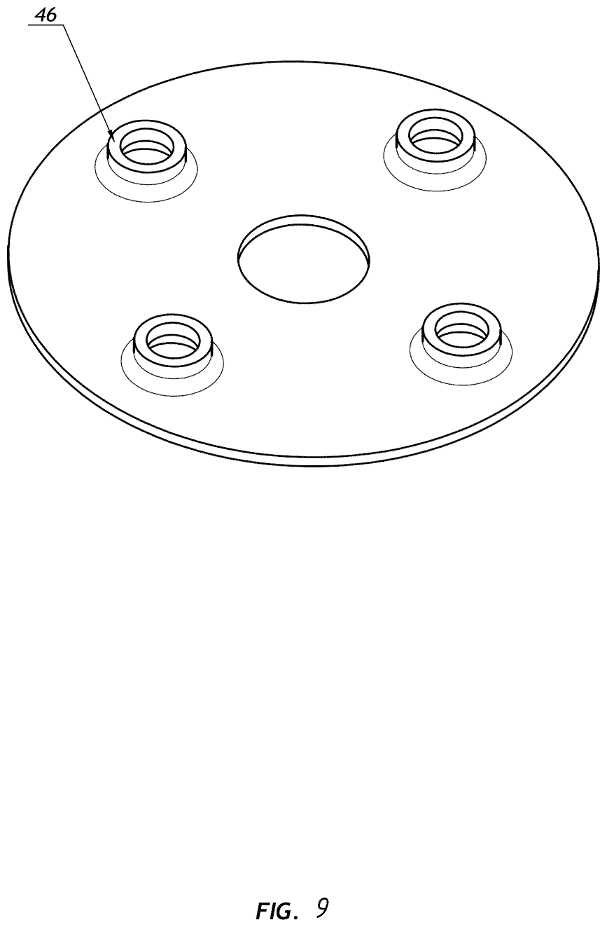

FIG. 10 shows the plate of the elastic element with the ledges in the shape of sharp pins-teeth.

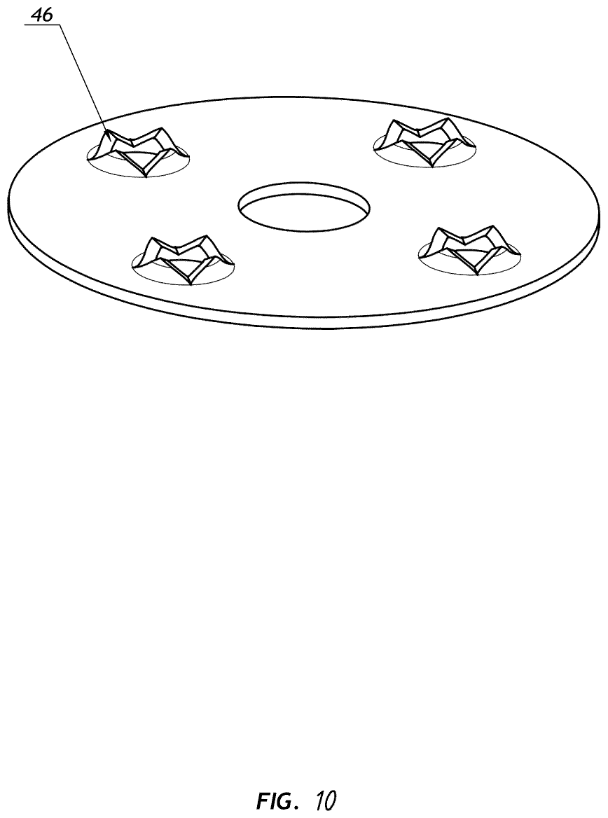

### DETAILED DESCRIPTION OF THE PREFERRED EMBODIMENT

In the preferred variant, the shock-absorbing unit includes housing 1 with a closed end part 2 and an opposite open end part 3, through which the main axis 4 passes, a friction system located in the open part 3 of the housing, a guide pin 14, an elastic system including a dynamic load absorber 16 formed by an elastic elements unit 45, formed by two plates 18 and an elastomeric element 17 mounted between them. The housing of the shock-absorbing unit, the guide pin 14 and the friction system are preferably made of solid metals and the elastomeric element is made of synthetic materials (for example of polymeric materials).

The friction system includes friction wedge 4, located on the main axis 4 of housing 1, one end of which extends from the open end part 3 of housing 1 and the second end is located at the top of the open part of housing 3. The first 6 and the second 7 friction shoes located on both sides of friction wedge 5. The first friction shoe 6 has the first 6a, the second 6b and the third 6c inclined surfaces. The second friction shoe 7 has the first 7a, the second 7b and the third 7c inclined surfaces. Whereby, the first inclined surface 5a of friction wedge 5 interacts with the first inclined surface 6a of the first friction shoe 6 and the second inclined surface 5b of friction wedge 5 interacts with the first inclined surface 7a of the second friction shoe 7. The first inclined surface 5a and the second inclined surface 5b of friction wedge 5 and the first inclined surface 6a, 7a of each friction shoe 6, 7 are located relative to the main axis of the housing at the first pre-determined angle a, which is about 45±5°, preferably 45°.

In addition, the friction system includes the first 8 and the second 9 barrier plates. The first barrier plate 8 is located on the side of the first friction shoe 6 and the second barrier plate 9 is located on the side of the second friction shoe 7. The first barrier plate 8 has the inclined surface 8a. The second barrier plate 9 has the inclined surface 9a as well. Whereby, the inclined surface 8a of the first barrier plate 8 interacts with the second inclined surface 6b of the first friction shoe 6 and the second inclined surface 9a of the second barrier plate 9 interacts with the second inclined surface 7b of the second friction shoe 7. The inclined surface 8a and 9a of each barrier plate 8, 9 and the second inclined surface 6b, 7b of each friction shoe 6, 7 are located relative to the main axis of the housing under the second pre-determined angle, which is about 4±3°, preferably 4°.

In addition, the friction system includes the first 10 and the second 11 U-shaped friction plates. Whereby the first U-shaped friction plate 10 is located on the side of the first barrier plate 8 and the second U-shaped friction plate 11 is located on the side of the barrier plate. The first 12 and the second 13 wear liners are isolating housing 1 from the frictional impact of the movable elements. Moreover, the first wear liner 12 is located on the side of the first U-shaped friction plate 10 and the second wear liner 13 is on the side of the second U-shaped friction plate 11 and fixed in the slots of the side walls of housing 1. The use of wear liners 12, 13 allows housing 1 of the shock-absorbing unit to be made of a polymer material, since liners 12, 13 isolate the walls of housing 1 from the moving parts of the housing. This ensures the absence of friction surfaces of housing 1 with moving parts, which leads to the absence of wear of the housing walls, an increase of the resource and the reliability of the shock-absorbing unit.

To ensure the wear resistance of the unit parts, friction shoes 6, 7 from the side of the barrier plates 8, 9 and U-shaped friction plates 10, 11 from the side of the barrier plates 8, 9 and from the side of the wear liners 12, 13 are equipped with lubricating liners 26, which, as a result of friction, provide a solid (dry) lubrication of the walls of the friction shoes 6, 7 and U-shaped friction plates 10, 11 and prevent fast wear of the parts.

Each lubricating liner 19 can be made in one, two or three layers. It is reasonable to use three-layer lubricating liners 19. The first layer, which is in contact with the surface of friction shoes 6, 7 and U-shaped friction plates 10, 11 includes large abrasive particles and accelerates the surfaces running-in process. The second (middle) layer contains a lubricant with a finer dispersed abrasive grain than in the first layer, which increases the surface cleanliness of the friction pairs of the barrier plates 8, 9 with friction shoes 6, 7, the barrier plates 8, 9 with U-shaped friction plates 10, 11 and U-shaped friction plates 10, 11 with wear liners 12, 13. The third layer, which is in contact with the surface of the separation plates 8, 9 and wear liners 12, 13 ensures that the required coefficient of friction is achieved and reduces parts wear after the first two layers perform their function. For the manufacture of liners 19, softer metals are used than the metal of the friction elements (for example copper, brass, graphite), or other materials with the addition of harder metals in the first two layers than the metal of the friction elements (for example diamond powder). Moreover, the abrasiveness of the second layer is less than the first and the third layer is not abrasive and consists of soft material only (softer than the metal of the friction elements).

Lubricating liners 19 are made by pressing abrasive and lubricant powders into sheets, followed by stamping of liners. The liners are placed into the friction elements by means of pressing during assembly.

The friction system also includes the compression element 15 formed with the first inclined surface 15a that interacts with the third inclined surface 6b of the first friction shoe 6 and the second inclined surface 15b that interacts with the third inclined surface 7c of the second friction shoe 7. Moreover, each inclined surface 15a, 15b of the compression element 15 and the third inclined surface 6c, 7c of each friction shoe 6, 7 is located relative to the main axis of the housing under the third pre-determined angle y, which is about 75±5°, preferably 75°.

The compression element has ledges interacting with the ledges of each U-shaped friction plate, designed to return U-shaped friction plates to their initial position after each stress or force influencing the shock-absorbing unit.

The internal horizontal surface 20 of the compression element 15 is made integral and generally flat with the possibility of interaction with the dynamic load absorber 16, consisting of elastic elements units 45 formed by two plates 18 and installed between them elastomeric element 17. Moreover, each plate 18 is made with hole 49 in its center, in which guiding element 14 is located, which is mounted in the closed part 2 of housing 1.

The compression element 15 is made with hole 21, located coaxially on the main axis of the housing and designed for centering relatively to the main axis of the housing, dynamic load absorber 16, consisting of elastic elements units 45 formed by two plates 18 and installed between them elastomeric element 17 and guide pin 14 by installing in hole 21 of the part of guide pin 14.

In the preferred variant, housing 1 is made with U-shaped ledges 26 on the internal surfaces of the open end part 3 of housing 1. Moreover, each U-shaped ledge 26 is made with a flat or concave lower surface 27. The friction wedge 5 is made with support arms 28 made with the upper flat or convex surface 29 and the lower ledge 30. The compression element is made with slots 31. Whereby the lower ledges 30 of support arms 28 of friction wedge 5 are located in slots 31 of compression element 15 with the technological gap, thus providing additional mutual positioning of friction wedge 5 relative to pressure element 15 and accidental disassembly of the shock-absorbing unit is prevented.

In the preferred variant, the dynamic load absorber 16 is a unit of elastic elements 45 formed by two plates 18 and elastomeric element 45 formed by two plates 18 and elastomeric element 17 mounted between them, which is made of thermoplastic polyester elastomeric material. Moreover, each plate 18 of elastic element 45 concentrically mounted on guide pin 14. Each elastomeric element 17 is made with a central hole and has a generally cylindrical shape. The elastomeric elements 17 are located in the closest part of housing 2, so that their holes are placed on the main axis of the housing. Each plate 18 of each elastic element 45 is made with ledges 46, so that ledges 46 of plate 18 interact with the upper surface 47 and the lower surface 48 of the elastomeric element and provide relative positioning of respective plates 18 and elastomeric element 17. Moreover, each plate 18 of elastomeric element 45 is made with central hole 49, placed on the main axis of the housing with the information of the central tubulated hole 22, passing through all plates 18, located along the main axis and allowing to center elastomeric elements 17 and plate 18 relative to the main axis and guide pin 14 by means of the location of its part in hole 22.

On the internal horizontal surface of the closed part 2 of the housing, conical or cylindrical slot 23 is made, which is located on the main axis of the housing and is intended to be centered relative to the main axis of the housing of guide pin 14 by means of guide pin 14 installed in slot 30 of head 24, pressed and fixed by the lower plate 18.

In the preferred variant, barrier plate 8 and 9 is made on opposite sides with lateral ledges 32 and 33 in the lower part. Moreover, each lateral ledge 32 and 33 of barrier plate 8 and 9 is made with a lower horizontal flat or convex surface 34, the upper horizontal flat or convex surface 35, vertical lateral surface 36. The housing is made with C-shaped oppositely directed ledges 37 located on opposite sides of the lower part. Whereby each C-shaped ledge 37 is made with the lower horizontal flat or concave surface 38, the upper horizontal flat or concave surface 39, vertical lateral surface 40. Moreover, each lateral ledge 32 and 33 of each plate of barrier 8 and 9 is located inside the relative C-shaped ledge 37 on opposite sides of the lower part of housing 1, so that the lower horizontal flat of convex surface 38 of each C-shaped ledge 37 of housing 1 in the lower part interacts with the lower horizontal flat or convex surface 34 of the relative lateral ledge 32 and 33 of barrier plate 8 and 9. The upper horizontal flat or concave surface 39 of each C-shaped ledge 73 of housing 1 in the lower part is located with the technological gap from the upper horizontal flat or convex surface 35 of the relative lateral ledge 32 and 33 of barrier plate 8 and 9. The lateral vertical surface 40 of each C-shaped ledge 37 of housing 1 in the lower part is located with the technological gap from the lateral vertical surface 36 of the relative lateral ledge 32 and 33 of barrier plate 8 and 9.

The compression element 15 is made with four ledges 41, whereby each ledge 41 is made with the upper surface 42. The first 10 and the second 11 U-shaped plates are made with lateral ledges 43, moreover, each ledge 43 is made with the surface of the bottom 44. In the assembled state of the unit, the bottom surface 44 of ledge 43 of the first 10 and the second 11 U-shaped plates interact with the surface of the upper 42 of the relative ledge 41 of compression element 15. During the compression of the unit between the surface of the upper 42 of ledge 41 of compression unit 15 and the surface of the lower 44 of ledge 43 of the first 10 and the second 11 U-shaped plate a technological gap is formed. When the unit returns to its initial working position, the technological gap between the surface of the upper 42 of ledge 41 of compression unit 15 and the surface of the lower 44 of ledge 43 of the first 10 and the second 11 of the U-shaped plate closes and the surface of the lower 44 of ledge 43 of the first 10 and the second 11 of U-shaped plates is in contact with the surface of the upper 42 of the relative ledge 41 of compression element 15 ad interacts until the unit returns to its initial working position.

With this execution and placement of all design elements that are included in the elastic system and friction system, it becomes possible to ensure during operation of the announced device the working stroke of the shock-absorbing unit 110 mm to 120 mm. This, in turn, allows us to ensure compliance with the technical requirements, imposed in the Russian Federation and the CIS countries on shock-absorbing units of coupling (automatic coupling) devices of railway rolling stock and to increase energy intensity by increasing the area of friction surfaces while achieving the aforementioned technical result as well.

The assembly sequence of the shock-absorbing unit.

The dynamic load absorber 16 consisting of elastic elements unit 41 formed by two plates 18 and elastomeric element 17 installed between them, is mounted on guide pin 14, which has head 24. Then dynamic load absorber 16 consisting of elastic elements unit 41 formed by two plates 18 and elastomeric element 17 installed between them, together with guide pin 14 is installed in the closest part of housing 2 with head 24 of guide pin 14 into slot 23. On the top of the dynamic load absorber 16 consisting of elastic elements units 41 formed by two plates 18 and compression element 17 installed between them, compression element 15 is installed. Using a press forcing on the compression element 15, dynamic load absorber 16 consisting of elastic elements units 41 formed by two plates 18 and compression element 17 installed between them is compressed to a position that is fixed by a device inserted into the front holes in housing 1. Further, friction wedge 5 is lowered into housing 1 in a position rotated around axis 4 relative to the working position, so that a part of the guide element 14 is located in the hole of friction wedge 5 and support arms 28 of friction wedge 5 are below the upper end of U-shaped ledges 26 on the internal surfaces of the open end part 3 of housing 1. Furthermore, the friction wedge 5 is rotated and set to its original position, so that the support arms 28 of friction wedge 5 are in contact with the upper flat or convex surface 29 with flat or convex surface 27 of the upper end of U-shaped ledge 26 on the internal surfaces of the open end part 3 of housing 1. Then, friction shoes 6, 7 are simultaneously installed. Then barrier plates 8, 9 are installed. Then, wear liners 12, 13 are installed and fixed in the slot of the lateral walls of housing 1. Then, U-shaped friction plates 10, 11 are installed, so that the lateral ledges 33 of U-shaped friction plates 10, 11 are in contact with the separated protrusions 34 of compression element 15. Using a press forcing on the friction wedge 5, which acts on the entire friction system, dynamic load absorber 16, consisting of elastic elements units 41 formed by two plates 18 and elastomeric element 17 installed between them is compressed to a position when the device is taken out. Then, the load is removed from friction wedge 5 from the side of the press. All details of the shock-absorbing unit take their initial working position. Meanwhile, the lower ledges 30 of support arms 28 of friction wedge 5 are located in slot 31 of compression element 15 with the technological gap, thus providing additional mutual positioning of friction wedge 5 relative to pressure element 15 and the accidental disassembly of the shock-absorbing unit is prevented.

The shock-absorbing unit works as follows.

When a dynamic shock load forces on friction wedge 5, the force is transmitted to the first 6 and the second 7 friction shoes, barrier plates 6, 7, creating the friction force of the friction surfaces in pairs: friction wedge 5 and friction shoe 6 (7). The first 6 and the second 7 friction shoes transmit the force from friction wedge 5 to the first 8 and the second 9 barrier plates, respectively, and compression element 15. The first 8 and second 9 barrier plates transmit the force from the first 6 and the second 7 friction shoes to the first 10 and second 11U-shaped friction plates, respectively. The first 10 and the second 11 U-shaped friction plates transfer force from the first 8 and the second 9 barrier plates to the first 12 and the second 13wear liners, respectively. The first 12 and the second 13 wear liners are installed in the slots of the lateral walls of housing 1 and are static relative to it. At the same time, the forces from the first 6 and the second 7 friction shoes exert influence on compression element 15, creating the friction force of the friction surfaces at the contact points. The compression element 15 transfers the force from the first 6, the second 7 friction shoes to the dynamic load absorber 16 consisting of elastic elements units 41 formed by two plates 18 and compression element 17 installed between them, which is installed in the closed part of housing 2 without axial bias and has a support contact surface. On the top of the dynamic load absorber 16 consisting of elastic elements units 41 formed by two plates 18 and compression element 17 installed between them, compression element 14 is installed.

1. A shock-absorbing unit comprising:
a hollow housing having a closed end part and an opposite opened end part, wherein the housing has a main axis passing through the closed end part and the opened end part;
an elastic system arranged in a lower part of the housing; and
a friction system arranged in the opened end part of the housing;
wherein the friction system comprises:
a friction wedge arranged on the main axis of the housing, the friction wedge having first end extending from the housing and a second end arranged above the opened part of the housing, the friction wedge having a first inclined surface and a second inclined surface;
a first friction shoe and a second friction shoes which are arranged on either sides of the friction wedge, wherein each of the first friction shoe and the second friction shoe has a first inclined surface, a second inclined surface, and a third inclined surface, the first inclined surface of the friction wedge engages with the first inclined surface of the first friction shoe, and the second inclined surface of the friction wedge engages with the first inclined surface of the second friction shoe, wherein the first inclined surface and the second inclined surface of the friction wedge and the first inclined surface of each of the first friction shoe and the second friction shoe is arranged at a first predefined angle relative to the main axis of the housing;
a first barrier plate and a second barrier plate, wherein the first barrier plate is arranged on the side of the first friction shoe and the second barrier plate is arranged on the side of the second friction shoe, each of the first barrier plate and the second barrier plate has an inclined surface, wherein the inclined surface of the first barrier plate engages with the second inclined surface of the first friction shoe and the inclined surface of the second barrier plate engages with the second inclined surface of the second friction shoe, wherein the inclined surface of each of the first barrier plate and the second barrier plate and the second inclined surface of each of the first friction shoe and the second friction shoe are arranged at a second predefined angle relative to the main axis of the housing;
a first U-shaped friction plate and a second U-shaped friction plate, wherein the first shaped friction plate is arranged on the side of the first barrier plate and the second U-shaped friction plate is arranged on the side of the second barrier plate;
a first wear liner and a second wear liner, wherein the first wear liner is arranged on the side of the first U-shaped friction plate and the second wear liner is arranged on the side of the second U-shaped friction plate, the first wear liner and the second wear liner being fixed in slots of side walls of the housing;
a compression element having a first inclined surface and a second inclined surface, each of which engages with the third inclined surface of the corresponding friction shoe, wherein the first inclined surface and the second inclined surface of the compression element and the third inclined surface of each of the first friction shoe and the second friction shoe are arranged at a third predefined angle relative to the main axis of the housing;
wherein the elastic system is formed by a dynamic load absorber arranged in the closed end part of the housing along the main axis of the housing on a guide pin
wherein the compression element has a flat inner horizontal surface configured to engage with the dynamic load absorber arranged in the closed end part of the housing;
wherein, in the center of the compression element, there is a hole aligned with the main axis of the housing for centering relative to the main axis by placing, in the hole, a part of the guide pin arranged along the main axis of the housing;
wherein the dynamic load absorber is formed by a unit of elastic elements arranged on
the guide pin perpendicular to the main axis of the housing,
characterized in that
each elastic element of the unit of elastic elements is formed by two plates and an elastomeric element installed between the two plates;
each plate of each elastic element of the unit of elastic elements has ledges such that
the ledges of the plate engage with an upper surface and a lower surfaces of the elastomeric element and provide relative positioning of the corresponding plates and elastomeric element;
each plate has, in the center, a hole aligned with the main axis of the housing for centering relative to the main axis of the housing by placing, in the hole, the part of the guide pin;
the friction wedge has support arms each having an upper flat or convex surface having
a lower ledge, wherein the compression element has slots and is arranged such that lower ledges of the support arms of the friction wedge are arranged in the slots of the compression element with a technological gap to ensure mutual positioning of the friction wedge relative to the compression element and to prevent accidental disassembly of the shock-absorbing unit;
the barrier plate has lateral ledges in the lower part on opposite sides, wherein each of
the lateral ledges of the barrier plate has a lower horizontal flat or convex surface, an upper horizontal flat or convex surface, a vertical lateral surface;
the housing has U-shaped ledges arranged on opposite inner surfaces of the opened
end part of the housing and oppositely directed C-shaped ledges arranged on opposite sides of the lower part, wherein each of the U-shaped ledges has a flat or concave lower surface configured to engage with the corresponding surfaces of the support arms of the friction wedge, and each of the C-shaped ledges has a lower horizontal flat or concave surface, an upper horizontal flat or concave surface and a side vertical surface,
each lateral ledge of each barrier plate is arranged inside the corresponding C-shaped
ledge on opposite sides of the lower part of the housing such that the lower horizontal flat or concave surface of each of the C-shaped ledges of the housing in the lower part engages with the lower horizontal flat or convex surface of the corresponding lateral ledge of the barrier plate, wherein the upper horizontal flat or concave surface of each of C-shaped ledges of the housing in the lower part is arranged with a technological gap from the upper horizontal flat or convex surface of the corresponding lateral ledge of the barrier plate, wherein the lateral vertical surface of each of the C-shaped ledges of the housing in the lower part is arranged with a technological gap from the lateral vertical surface of the corresponding lateral ledge of the barrier plate;
the guide pin has a head, wherein there is a conical or cylindrical slot on the internal horizontal surface of the closest end part of the housing, the conical or cylindrical slot being arranged on the main axis of the housing and configured to center the guide pin relative to the main axis of the housing by placing, in the slot, the head of the guide pin pressed and fixed by the lower plate of the lower elastic element;
all the structural elements of the friction system and the elastic system are configured and arranged such that the shock-absorbing unit has a working stroke of 110 mm to 120 mm.

2. The shock-absorbing unit of claim 1, wherein the first predefined angle is about 45±5°, the second predefined angle is about 4±3°, and the third predefined angle is about 75±5°.

3. The shock-absorbing unit of claim 1, wherein the wear liners are equipped with lubricating liners.

4. The shock-absorbing unit of claim 3, wherein the lubricating liners are installed on the side of the U-shaped friction plates.

5. The shock-absorbing unit of claim 1, wherein the barrier plates are equipped with lubricating liners.

6. The shock-absorbing unit of claim 5, wherein the lubricating liners are installed on the side of the U-shaped friction plates.

7. The shock-absorbing unit of claim 5, wherein the lubricating liners are installed on the side of the U-shaped friction shoes.

8. The shock-absorbing unit of claim 1, wherein the ledges of the plate of the elastic element have a cylindrical shape.

9. The shock-absorbing unit of claim 1, wherein the ledges of the plate of the elastic element are shaped as sharp pins-teeth.
